(19) United States
(12) Patent Application Publication
(10) Pub. No.: US 2021/0321748 A1
(43) Pub. Date: Oct. 21, 2021

(54) DYNAMIC SELF-ADJUSTING CARRYING CASE

(71) Applicants: Ebin John Daniel, Indianapolis, IN (US); Raunak Vivek Kelshiker, Indianapolis, IN (US); Edwin Jacob VanBaale, Indianapolis, IN (US); Karina Sofia-Juliana Gonzalez de Graaf, Indianapolis, IN (US); Kalin Jovaun Nichols, Indianapolis, IN (US)

(72) Inventors: Ebin John Daniel, Indianapolis, IN (US); Raunak Vivek Kelshiker, Indianapolis, IN (US); Edwin Jacob VanBaale, Indianapolis, IN (US); Karina Sofia-Juliana Gonzalez de Graaf, Indianapolis, IN (US); Kalin Jovaun Nichols, Indianapolis, IN (US)

(21) Appl. No.: 16/852,017

(22) Filed: Apr. 17, 2020

(51) Int. Cl. A45F 3/04; G01C 19/00; G01L 5/04

(52) U.S. Cl. CPC A45F 3/047; A45F 2003/001; G01L 5/04; G01C 19/00

(57) ABSTRACT

A carrying case adapted to be worn by a user is disclosed, which includes a power source, a central controller, and a plurality of self-adjusting strap units, each unit including a motor coupled to and powered by the power source, a strap having a fixed connection point and an adjustable connection point, a buckle coupled to the motor providing an adjustable connection for the strap, and a sensor in communication with the central controller and adapted to measure mechanical characteristics of the strap and communicate to the central controller, the central controller in response to the sensor is configured to actuate the motors.

### TECHNICAL FIELD

The present disclosure generally relates to a carrying case, particularly to a carrying case with self-adjusting straps.

### BACKGROUND

This section introduces aspects that may help facilitate a better understanding of the disclosure. Accordingly, these statements are to be read in this light and are not to be understood as admissions about what is or is not prior art.

This patent relates specifically to a carrying case with dynamic self-adjusting straps. The present disclosure can be applied not only to bookbags and backpacks, but to a wide variety of carrying cases known in the art. Ordinary carrying cases that are used by students, professionals, and travelers who possibly need to carry a heavy load including a laptop, textbooks, notebooks, etc. distributes the loads onto the shoulders and lower back. The designs provide an uneven distribution of load which is not suitable for the user. These designs require manual adjustments which can be cumbersome. The straps from carrying cases within the art contain a passive system with elastic and excess material straps, whereas the current presented system is an active system sending sensor readings to the central controller in communication with the motors-buckle assembly on the self-adjusting straps. This would allow the user to apply a load of their choosing, then the straps would adjust to allow for the best possible posture to avoid back strain and injury. A load can be applied to an ordinary backpack, but then the user has to choose where they want the backpack to sit on their body, whether that be very low, below their back and possibly bending their back and shoulders, or very high, putting most of the weight on their shoulders and also causing a high center of gravity. This could cause an issue where if the user had to bend over and pick something up, the high set backpack would cause them to fall over or cause major difficulty getting back up. The switch that would activate the system would be integrated into the chest buckle. Once clipped, the motors would turn, tightening the straps. Additionally, conventional carrying cases have an exoskeleton for weight distribution, where as our design uses an internal gyro-meter sensor to give orientation reading to the central controller. The carrying case is constantly taking sensor readings throughout the commute of travel. If the user were to carry an item that is constantly moving within the bag such as a small child or animal, the sensor send necessary readings to the controller to then communicate to the motor-buckle assemble the necessary adjustments of the straps the keep the carrying case at optimal acclimatization on the user's back. Therefore, there is an unmet need for a novel approach for self-adjusting straps on wide variety of carrying cases that contain un-even loads or loads that create internal movement within the carrying case.

### SUMMARY

A carrying case adapted to be worn by a user. The carrying case includes, a power source, a central controller; and a plurality of self-adjusting strap units. Each self-adjusting unit includes a motor coupled to and powered by the power source, a strap having a fixed connection point and an adjustable connection point, a buckle coupled to the motor providing an adjustable connection for the strap, and a sensor in communication with the central controller and adapted to measure mechanical characteristics of the strap and communicate to the central controller. The central controller in response to the sensor is configured to actuate the motors.

A method of adjusting a carrying case on a user is disclosed. The method includes a central controller receiving a plurality of signals from associated sensors of a plurality of self-adjusting strap units. The method further includes actuating an associated motor of each of the plurality of the self-adjusting strap units based on the received sensor signals. Each strap unit includes a motor coupled to and powered by a power source, a strap having a fixed connection point and an adjustable connection point, a buckle coupled to the motor providing an adjustable connection for the strap, and a sensor in communication with the central controller and adapted to measure mechanical characteristics of the strap and communicate to the central controller.

### BRIEF DESCRIPTION OF DRAWINGS

FIG. 1 is a rear view of the bag with the placement of the components that work in cohesion to perform the described functions.

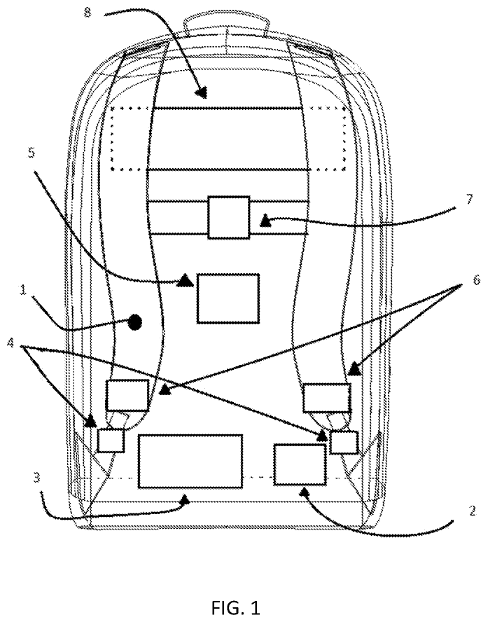

FIG. 2 is an enhanced view of the shoulder strap adjuster system located at the lower end of the bag's shoulder straps.

FIG. 3 is an enhanced view of the counter-weight adjustment system located on the upper back of the backpack.

FIG. 4 is an enhanced view of the chest-strap adjustment system located along the chest-strap of the bag.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

The present disclosed subject matter is directed to carrying cases having self-adjusting straps, such as carrying case for items such as books, food, and small children and animals. When activated, the straps can lengthen and contract in response to the sensor readings sent to a central controller. These readings are taken to balance loads and orientation of the carrying case.

The present disclosure features an active dynamic backpack adjustment system that varies the length of the shoulder straps and chest strap, and ensures an equal weight distribution on both shoulders to improve the fit of the backpack on the user. The present disclosure has three processes, all of which turn on with the help of an On/Off switch 1, powered by a power source 3 and whose functions are controlled by a central controller 2.

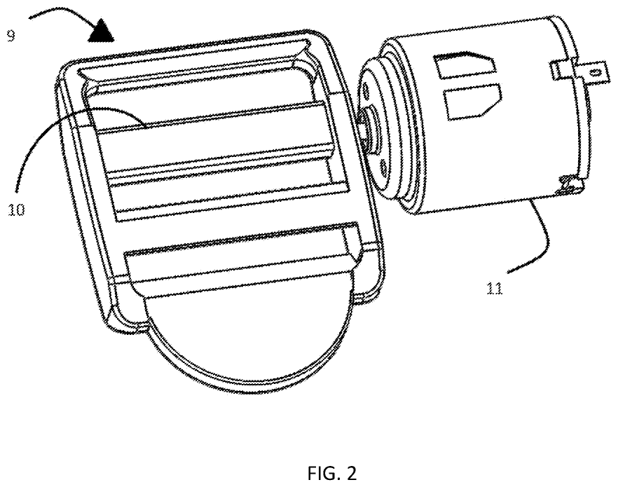

The first process to start is the shoulder strap adjustment process. Once the user wears the bag and turns on the entire system, the tension sensors 4 read the forces experienced by both shoulder straps and the data is sent to the central controller 2. Once the average of the two forces are calculated, the shoulder strap lengths are adjusted for the most comfort by the automatic shoulder adjustment system 6. The basic setting of the process is to have the bag placed higher on the user's back by shortening the length of the shoulder strap when the force is on the higher end of the weight range of the backpack and vice versa when the force is on the lower end. FIG. 2 shows the automatic shoulder adjustment system comprising of a shoulder strap adjuster 9 connected to a special DC motor 11 that locks in the position that it has been set to, connected by a singular shaft 10. Once the central controller 2 determines the required length of the shoulder straps, a signal is sent to the motors 11 that rotate the shaft 11 within the strap adjuster 10 to change the length of the strap to reach the required length. Once the required length has been reached, the motor locks in place to ensure the length does not change while the user moves around. The process repeats again after a set interval to ensure the right level of the bag is on the user's back at all times, even if additional weight is added while the system is on.

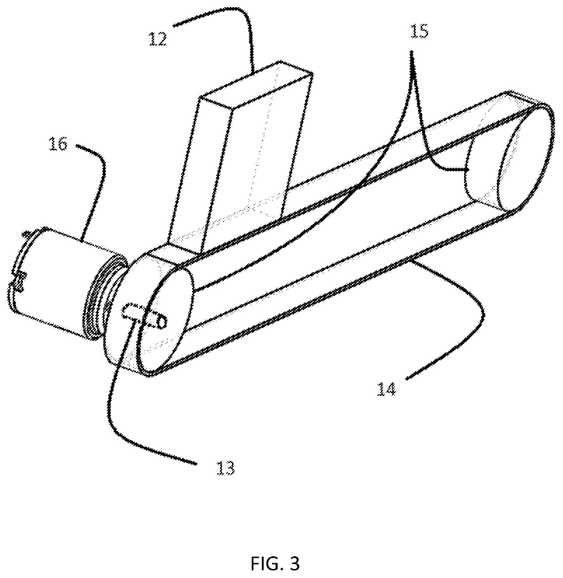

The second process is a counter-weight adjustment process that begins immediately after the first iteration of the shoulder strap adjustment process. While the entire system is on, the tension sensors 4 read the force experienced by each of the shoulder strap and relay the data to the central controller 2 where they are compared to determine the direction the counter-weight 12 should move towards so that the weight experienced on each shoulder is equal. This ensures that the shoulders stay level and thus minimize any lateral twisting of the spine. FIG. 3 shows the counter-weight system 8 that comprises a counter-weight 12, two belt rollers 15, a belt 14 and a DC motor 16 similar to the one used in the previous process. This sub-system can be placed in a rectangular casing placed just under the location where the shoulder straps attach to the upper end of the bag and spans over the entire width of the backpack as shown in FIG, 1 8. The casing may be within the bag or placed on the outside. To ensure that equal weight is experienced on both shoulders, the counter-weight system 8 places the counter-weight 12 closer to the shoulder strap that is experiencing the lower force. The counter-weight 12 continues to move in the determined direction until the forces read by the tension sensors 4 are equal. This is done by attaching the counter-weight 12 to a belt 14 that is set over two belt rollers 15, of which one of the two belt rollers 15 is attached to the motor 16 through a singular shaft 13. To move the counter-weight 12, the motor 16 rotates the shaft 13 connected to one of the belt rollers 15 which in turn rotates the belt 14 that ultimately moves the counterweight in the intended direction. Once the required location of the counter-weight 12 has been reached, the motor locks in place to ensures the location does not change while the user moves around. The process repeats again after a set interval to ensure the equal weights on both shoulder at all times even if the objects within the bag moves about when the user moves about while the system is on.

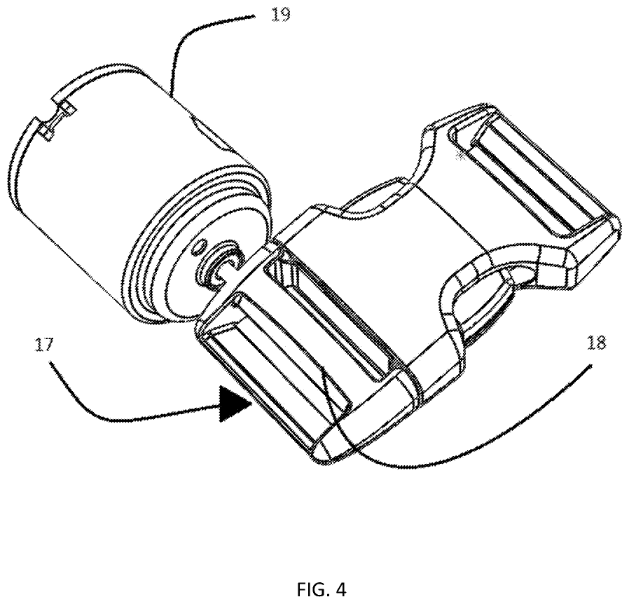

The third process is a chest-strap adjustment process that begins simultaneously with the counter-weight adjustment process, i.e. it begins after the first iteration of the shoulder strap adjustment process. While the entire system is on, the gyro-meter 5 reads the orientation of the bag relative to the ground and sends the data to the central controller 2 where it is used to determine the functioning of the automatic chest adjuster system. The basic functioning of this process is to tighten whenever the bag and user lean forwards, which is typical when a person is moving up an inclined plane, to give additional support, and to loosen when the user is walking on neutral ground for more comfort. This system, as shown in FIG. 4 consists of a side-release buckle 17 and a DC motor 19 is similar to the one used in the previous process. Once the appropriate setting is chosen by the central controller, a signal is sent to activate the motor 19. The motor then rotates a shaft 18 connected to the side-release buckle 13 to the appropriate degree in the determined direction. The rotation of the shaft will shorten or lengthen the chest-strap as required. Once the required length has been reached, the motor locks in place to ensure the length does not change while the user moves around. The process repeats again after a set interval to ensure the right support of the bag on the user's back at all times whether the user is moving on an inclined or a neutral surface while the system is on.

Those having ordinary skill in the art will recognize that numerous modifications can be made to the specific implementations described above. The implementations should not be limited to the particular limitations described. Other implementations may be possible.

1. A carrying case adapted to be worn by a user, comprising:
a power source;
a central controller; and
a plurality of self-adjusting strap units, each unit including
a motor coupled to and powered by the power source,
a strap having a fixed connection point and an adjustable connection point,
a buckle coupled to the motor providing an adjustable connection for the strap, and
a sensor in communication with the central controller and adapted to measure mechanical characteristics of the strap and communicate to the central controller;
wherein the central controller in response to the sensor is configured to actuate the motors.

2. The carrying case of claim 1, the plurality of strap units includes two shoulder strap units each adapted to be worn over a shoulder of a user, and wherein each sensor of each shoulder strap unit is coupled to the associated strap and is a load sensor adapted to measure load applied to the associated strap, and wherein the central controller is adapted to actuate each motor in response to load information from each associated sensor.

3. The carrying case of claim 2, wherein the central controller during an initialization phase is adapted to actuate motors of each of the two shoulder strap units to thereby result in equal lengths on the two straps in response to the associated sensors of each shoulder strap unit.

4. The carrying case of claim 3, wherein the central controller is further adapted to continually actuate the motors of the two shoulder strap units after the initialization phase in further response to the associated sensors of each should strap unit, to thereby maintain equal lengths on the two straps.

5. The carrying case of claim 2, the plurality of strap units includes a chest strap unit adapted to adjust orientation of the carrying case by adjusting the strap of the chest strap unit.

6. The carrying case of claim 5, wherein the predetermined orientation is defined by the sensor.

7. The carrying case of claim 6, wherein the sensor of the chest strap unit is a gyro-sensor adapted to provide signal associated with orientation of the carrying case.

8. The carrying case of claim 6, wherein the central controller maintains a nominal tension on the strap of the chest strap unit by actuating the motor of the chest strap unit when output of the sensor of the chest strap unit is within a predetermined threshold.

9. The carrying case of claim 8, the plurality of strap units includes a counterweight system having a movable counterweight coupled to a belt and selectively positioned by a motor, the counterweight system adapted to shift the movable counterweight of the carrying case from a nominal position according to sensor data obtained from the two should strap units and the associated sensors.

10. The carrying case of claim 2, the plurality of strap units includes a counterweight system having a movable counterweight coupled to a belt and selectively positioned by a motor, the counterweight system adapted to shift the movable counterweight of the carrying case from a nominal position according to sensor data obtained from the two should strap units and the associated sensors.

11. A method of adjusting a carrying case on a user, comprising:
a central controller receiving a plurality of signals from associated sensors of a plurality of self-adjusting strap units; and
actuating an associated motor of each of the plurality of the self-adjusting strap units based on the received sensor signals;
wherein each strap unit includes:
a motor coupled to and powered by a power source,
a strap having a fixed connection point and an adjustable connection point, a buckle coupled to the motor providing an adjustable connection for the strap, and
a sensor in communication with the central controller and adapted to measure mechanical characteristics of the strap and communicate to the central controller.

12. The carrying case of claim 11, the plurality of strap units includes two shoulder strap units each adapted to be worn over a shoulder of a user, and wherein each sensor of each shoulder strap unit is coupled to the associated strap and is a load sensor adapted to measure load applied to the associated strap, and wherein the central controller is adapted to actuate each motor in response to load information from each associated sensor.

13. The carrying case of claim 12, the central controller during an initialization phase actuating motors of each of the two shoulder strap units to thereby result in equal lengths on the two straps in response to the associated sensors of each shoulder strap unit.

14. The carrying case of claim 13, the central controller continually actuating the motors of the two shoulder strap units after the initialization phase in further response to the associated sensors of each should strap unit, to thereby maintain equal lengths on the two straps.

15. The carrying case of claim 12, the plurality of strap units includes a chest strap unit adapted to adjust orientation of the carrying case by adjusting the strap of the chest strap unit.

16. The carrying case of claim 15, wherein the predetermined orientation is defined by the sensor.

17. The carrying case of claim 16, wherein the sensor of the chest strap unit is a gyro-sensor adapted to provide signal associated with orientation of the carrying case.

18. The carrying case of claim 16, the central controller maintaining a nominal tension on the strap of the chest strap unit by actuating the motor of the chest strap unit when output of the sensor of the chest strap unit is within a predetermined threshold.

19. The carrying case of claim 18, the plurality of strap units includes a counterweight system having a movable counterweight coupled to a belt and selectively positioned by a motor, the counterweight system shifting the movable counterweight of the carrying case from a nominal position according to sensor data obtained from the two should strap units and the associated sensors.

20. The carrying case of claim 2, the plurality of strap units includes a counterweight system having a movable counterweight coupled to a belt and selectively positioned by a motor, the counterweight system shifting the movable counterweight of the carrying case from a nominal position according to sensor data obtained from the two should strap units and the associated sensors.
